(19) United States
(12) Patent Application Publication
(10) Pub. No.: US 2014/0372458 A1
(43) Pub. Date: Dec. 18, 2014

(54) Systems and Methods for Mapping Nodes of Disconnected Graphs

(71) Applicant: Google Inc., Mountain View, CA (US)

(72) Inventor: Radu Jurca, Zurich (CH)

(73) Assignee: Google Inc., Mountain View, CA (US)

(21) Appl. No.: 13/715,496

(22) Filed: Dec. 14, 2012

(51) Int. Cl. G06F 17/30

(52) U.S. Cl. CPC G06F 17/30867
USPC 707/754

(57) ABSTRACT

A computer-implemented method of associating a node of a first graph with a node of a second graph, each of the first and second graphs comprise sets of nodes each corresponding to a physical entity having a physical geographic location and one or more node attributes associated therewith. The method includes identifying a subject node of the first graph, filtering out nodes of the second graph that are unrelated to the subject node of the first graph to identifying a first subset of candidate nodes, identifying one or more first level edge attributes associated with the subject node, the first level edge attributes characterizing a relationship between the subject node and first level nodes of the first graph adjacent to the subject node, and filtering out nodes of the first subset of candidate nodes having first level edge attributes that do not correspond to the one or more first level edge attributes associated with the subject node to identifying a second subset of candidate nodes.

### BACKGROUND OF THE INVENTION

1. Field of the Invention

This invention relates generally to mapping similar elements of graphs and more particularly to mapping nodes of disconnected graphs.

2. Description of the Related Art

In some instances, databases of information may be represented graphically. For example, a database for a plurality of objects may be represented by a graph including nodes (e.g., a point on the graph) that each correspond to a given object, and edges (e.g., lines) extending between certain ones of the nodes. The edges may be associated with a relationship between two objects corresponding to the nodes connected by the edge. In some instances, each node may be associated with attributes (e.g., node attributes) corresponding to the object associated with the node. For example, a given node may be associated with node attributes indicative of a corresponding object's name, location and so forth. In some instances, edges may be associated attributes (e.g., edge attributes) indicative of the relationship between two nodes connected by the given edge. For example, an edge attribute may specify that the object corresponding with the first node is contained within the object corresponding to the second node.

In some instances, separate databases and corresponding graphs may include similar objects. For example, a first database including objects A, B and C may be similar to another database including objects B, C, and D. In some instances, each of the databases may include different information about each of the objects. For example, node of the first database may include location information for object B, whereas a node of the second database may include size information for object B. Often, database managers may want to combine multiple databases to consolidate information from the multiple databases. For example, a database manager may want to combine a first and a second database to generate a combined database that includes a consolidation of information for the databases, such as data for object B that includes both the location and size information for object B. Unfortunately, combining databases may be a difficult task given the nature of how databases may be created. For example, each database may give a different name to object B, and, thus, it may be very difficult to match a node of one database for object B with a first name with a node of another database for object B having a second name. Moreover, multiple entries may have similar names and it may be difficult to distinguish which of the multiple entries correspond to one another.

### SUMMARY OF THE INVENTION

Various embodiments of methods and apparatus for mapping similar nodes of graphs are provided herein. In some embodiments, provided is a computer-implemented method of associating a node of a first graph with a node of a second graph, each of the first and second graphs comprise sets of nodes each corresponding to a physical entity having a physical geographic location and one or more node attributes associated therewith. The methods include identifying a subject node of the first graph, filtering out nodes of the second graph that are unrelated to the subject node of the first graph to identify a first subset of candidate nodes, identifying one or more first level edge attributes associated with the subject node, the first level edge attributes characterizing a relationship between the subject node and first level nodes of the first graph adjacent to the subject node, and filtering out nodes of the first subset of candidate nodes having first level edge attributes that do not correspond to the one or more first level edge attributes associated with the subject node to identify a second subset of candidate nodes.

In some embodiments, provided is a non-transitory computer readable storage medium having computer-executable program instructions stored thereon that are executable by a computer to cause steps including identifying a subject node of a first graph comprising a set of nodes each corresponding to a physical entity having a physical geographic location and one or more node attributes associated therewith, filtering out nodes of a second graph that are unrelated to the subject node of the first graph to identify a first subset of candidate nodes, the second graph comprising a set of nodes each corresponding to a physical entity having a physical geographic location and one or more node attributes associated therewith, identifying one or more first level edge attributes associated with the subject node, the first level edge attributes characterizing a relationship between the subject node and first level nodes of the first graph adjacent to the subject node, and filtering out nodes of the first subset of candidate nodes having first level edge attributes that do not correspond to the one or more first level edge attributes associated with the subject node to identify a second subset of candidate nodes.

In some embodiments, provided is a system including a processor, a memory and a mapping module stored on the memory. The mapping module is configured to be executed by the processor to cause identifying a subject node of a first graph comprising a set of nodes each corresponding to a physical entity having a physical geographic location and one or more node attributes associated therewith, filtering out nodes of a second graph that are unrelated to the subject node of the first graph to identify a first subset of candidate nodes, the second graph comprising a set of nodes each corresponding to a physical entity having a physical geographic location and one or more node attributes associated therewith, identifying one or more first level edge attributes associated with the subject node, the first level edge attributes characterizing a relationship between the subject node and first level nodes of the first graph adjacent to the subject node, and filtering out nodes of the first subset of candidate nodes having first level edge attributes that do not correspond to the one or more first level edge attributes associated with the subject node to identify a second subset of candidate nodes.

In some embodiments, provided is a computer-implemented method for associating nodes of a first graph with nodes of a second graph disconnected from the first graph. The method includes identifying candidate nodes of the second graph that correspond to a subject node of the first graph by comparing node attributes of the nodes of the second graph to one or more node attributes of the subject node, and iteratively filtering, using a computer, the candidate nodes identified as corresponding to the subject node of the first graph by iteratively comparing increasing levels of edge attributes of the candidate nodes of the second graph remaining to corresponding levels of edge attributes of the subject node.

### BRIEF DESCRIPTION OF THE DRAWINGS

FIG. 1 is a diagram that illustrates an exemplary mapping system in accordance with one or more embodiments of the present technique.

FIGS. 2 and 3 are exemplary pictorial/diagrammatic representations of first and second graphs, respectively in accordance with one or more embodiments of the present technique.

FIGS. 4A and 5A are diagrams that illustrate exemplary node listings corresponding to nodes of the first and second graphs, respectively, in accordance with one or more embodiments of the present technique.

FIGS. 4B and 5B are diagrams that illustrate exemplary edge listings corresponding to edges of the first and second graphs in accordance with one or more embodiments of the present technique.

FIG. 6 is a flowchart that illustrates a method of mapping nodes of two disconnected graphs in accordance with one or more embodiments of the present technique.

FIG. 7 is a diagram that illustrates an exemplary mapping of nodes of the first graph to corresponding nodes of the second graph in accordance with one or more embodiments of the present technique.

FIG. 8 is a diagram that illustrates an exemplary combined node attribute listing in accordance with one or more embodiments of the present technique.

FIG. 9 is a diagram that illustrates an exemplary computer system in accordance with one or more embodiments of the present technique.

### DETAILED DESCRIPTION OF THE PREFERRED EMBODIMENTS

As discussed in more detail below, provided in some embodiments are systems and methods for mapping similar nodes of two disconnected graphs. In some embodiments, the two disconnected graphs may correspond to two databases of information that are to be combined/consolidated in to a single database or otherwise have at least some of their information combined/consolidated. In some embodiments, nodes of a first graph are associated with nodes of a second graph identifying a subject node of the first graph and filtering candidate nodes of the second graph to identify a node of the second graph that matches or otherwise corresponds to the subject node. In certain embodiments, for each node of the first graph (e.g., a subject node) an initial set of one or more candidate nodes of the second graph that relate to the subject node may be identified by initial filtering that includes comparing node attributes of the candidate nodes of the second graph to one or more node attributes of the subject node. In some embodiments, where a matching candidate node is not identified as a result of the initial filtering, additional filtering of the candidate nodes may be provided by iteratively comparing increasing levels of edge attributes of the remaining candidate nodes of the second graph to corresponding levels of edge attributes of the subject node. In certain embodiments, the iterative comparisons may continue until a matching candidate node is identified or it is determined that a matching candidate node may not be identified for the given subject node.

In certain embodiments, each of the nodes of the first graph may be processed in a similar manner in an attempt to map each node of the first graph to any corresponding nodes (e.g., matching nodes) of the second graph. In some embodiments, the mapping may be used to provide for combining/consolidating node and/or edge attributes of matching nodes of the first and second graphs. In some embodiments, the node and/or edge attributes may be combined into nodes of a single graph, node listing, edge listing, and/or database to generate a single concise and complete graph, node listing, edge listing and/or database including information derived from the first and the second graphs or associated listings/databases of information.

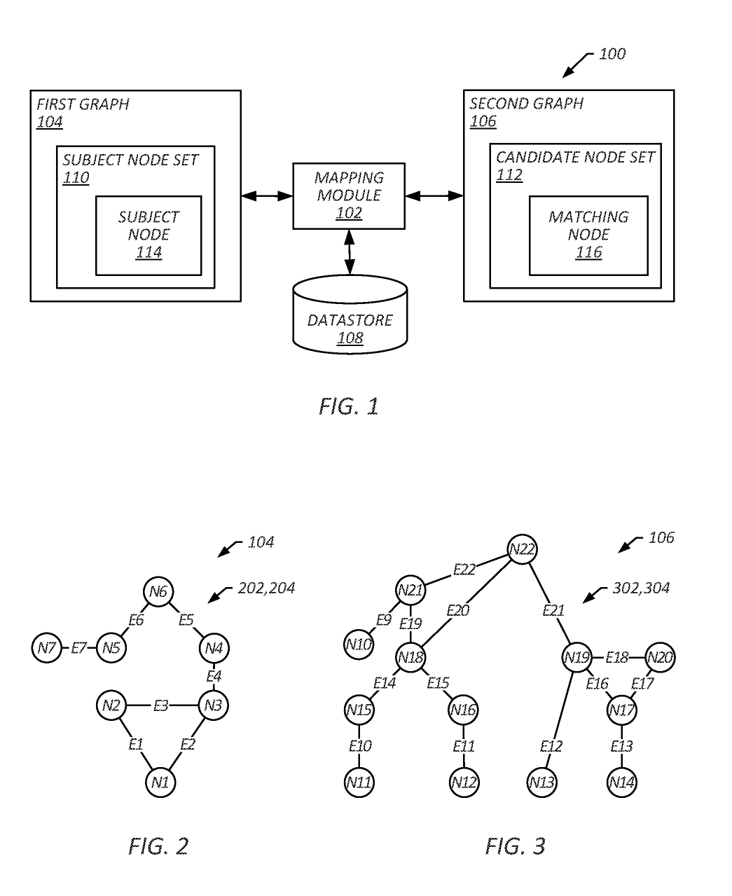

FIG. 1 is a diagram that illustrates an exemplary mapping system 100 in accordance with one or more embodiments of the present technique. As depicted, in some embodiments, mapping system 100 may include a mapping module 102, a first graph (e.g., “subject graph”) 104, a second graph (e.g., “candidate graph”) 106 and a datastore 108.

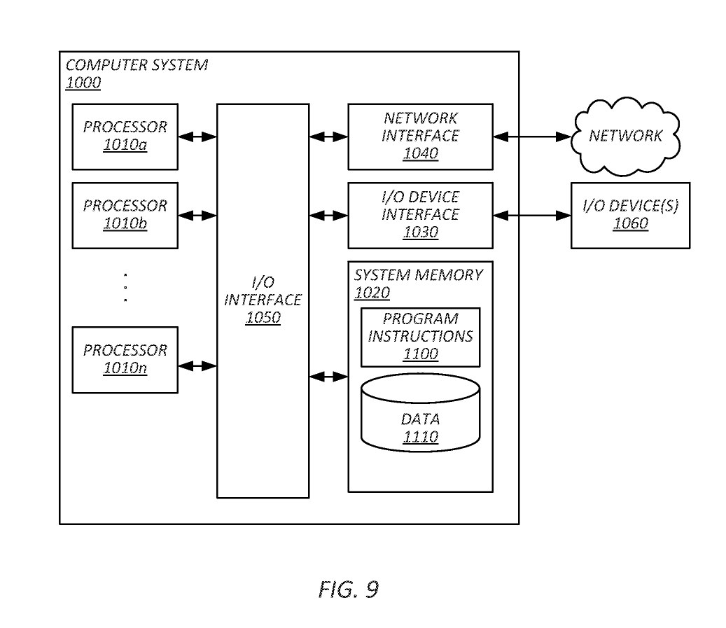

Mapping module 102 may include program instructions that are executable by a computer system to perform some or all of the functionality described herein with regard to at least system 100. For example, mapping module 102 may include an application or similar process that provides for identifying and mapping nodes of first graph 104 to corresponding nodes of second graph 106. In some embodiments, mapping module 102 may be implemented on a computer system similar to that of computer system 1000 described in more detail below with regard to at least FIG. 9.

First graph 104 and second graph 106 may each include a representation of plurality nodes that are each representative of an object. In some embodiments, graphs 104 and 106 may include a plurality of nodes that each correspond to a given geographical entity. For example, graphs 104 and 106 may each include a plurality of nodes that each represents a geographical object, such as place, landmark, business, street, neighborhood, city, county, state, or county, and so forth. First graph 104 may include a first set of nodes (e.g., a “subject node set”) 110 and second graph 106 may include a second set of nodes (e.g., a “candidate node set”) 112.

Each of the nodes may include one or more node attributes that define characteristics of the given node. For example, a node representing the geographic entity/object of New York City may include node attributes for the object such as an object identifier (e.g., name) such as “New York” associated with the node, location information indicative of a geographic location of the object associated with the node (e.g., latitude/longitude geographic coordinates), an object type indicative of a type of the object associated with the node (e.g., place, landmark, business, street, neighborhood, city, county, state, or county, and so forth). Nodes may be connected to other nodes of a graph via edges (e.g., links). Each of the edges may connect two nodes and may be associated with one or more edge attributes that define a relationship between the two nodes.

FIGS. 2 and 3 are exemplary pictorial/diagrammatic representations of graphs 104 and 106 in accordance with one or more embodiments of the present technique. Nodes may be represented by dots, and edges between two nodes may be represented by lines extending between dots corresponding to the two nodes. For example, first graph 104 may include nodes 202 (e.g., nodes N1-N7) and edges 204 (e.g., edges E1-E7), and second graph 106 may include nodes 302 (e.g., nodes N10-N22) and edges 304 (e.g., edges E9-E22). Although the illustrated embodiments include a given number of nodes and edges for the purposes of illustration, embodiments may include graphs 104 and 106 having any number of nodes and edges.

In some embodiments, some or all of the edges of a graph may include directed edges having an associated orientation/direction. For example, an edge (e.g., edge E4) extending between nodes corresponding to “New York City” and “New York State” (e.g., nodes N3 and N4, respectively) may be associated with an edge attribute that defines a containment specifying that “New York State” contains “New York City” (e.g., N4 contains N3). In some embodiments, some or all of the edges of a graph may include undirected edges that do not have an associated orientation/direction. For example, an edge (e.g., edge E4) extending between nodes corresponding to “New York City” and “New York State” (e.g., nodes N3 and N4, respectively) may be associated with an edge attribute that defines an overlap specifying that geographic areas of “New York State” and “New York City” overlap one another.

Two nodes for a given edge may be referred to as “ends” of the given edge. For example, nodes N1 and N3 may be referred to as ends of edge E2. Two edges may be referred to as “adjacent” or “coincident” where they share a common vertex/node/end. For example, edges E2 and E4 may be referred to as adjacent to one another based on their sharing of node N3. Two nodes may be referred to as “adjacent” or “coincident” where they share a common edge extending there between. For example, nodes N1 and N3 may be referred to as adjacent nodes to one another based at least on their sharing of edge E2. A node that is immediately adjacent to a given node may be referred to as a first level node with regard to the given node. For example, node N3 may be referred to as a first level node of N1. The node level naming convention may extend to additional levels of nodes. For example, node N4 may be referred to as a second level node of node N1 and so forth. An edge extending from a first node to a second (e.g., an adjacent) node may be referred to as a “first level edge” for the first node. For example, edge E2 may be referred to as a first level edge of node N1. The first level edge may be associated with “first level edge attributes” defining a relationship between the first and second nodes. For example, first level edge E2 may be associated with first level edge attributes defining a relationship between nodes N1 and N3. An edge extending from the second node to a third node that is adjacent to the second node (e.g., between a first level node and a second level node) may be referred to as a “second level edge” for the first node. For example, edge E4 may be referred to as a second level edge of node N1. The second level edge may be associated with “second level edge attributes” defining a relationship between the second and third nodes. For example, second level edge E4 may be associated with second level edge attributes defining a relationship between nodes N3 and N4. Such a naming convention of edge levels and corresponding edge attribute levels may extend iteratively between remote levels of adjacent nodes. For example, an edge (e.g., E5) extending from a third node (e.g., N4) to a fourth node (e.g., N6) that is that is adjacent to the third node may be referred to as a “third level edge” for the first node (e.g., N1), and so forth. The third level edge (e.g., E5) may be associated with “third level edge attributes” defining a relationship between the third and fourth nodes (e.g., nodes N4 and N6).

In some embodiments, first and second graphs 104 and 106 may include disconnected graphs. Disconnected graphs may include two distinct sets of nodes that are not interconnected via an edge. For example, an edge may not exist between any nodes of first graph 104 and any nodes of second graph 106.

In some embodiments, first and second graphs 104 and 106 may be defined by or otherwise associated with two separate databases of geographic nodes. For example, first graph 104 may be defined by a first set of database entries corresponding to each of the nodes of first graph 104 (e.g., a subject node listing of each of the nodes of subject node set 110) and/or each of the edges of first graph 104 (e.g., a subject edge listing), and second graph 106 may be defined by a second set of database entries corresponding to each of the nodes of second graph 106 (e.g., a candidate node listing of each of the nodes of candidate node set 112) and/or each of the edges of second graph 106 (e.g., a candidate edge listing).

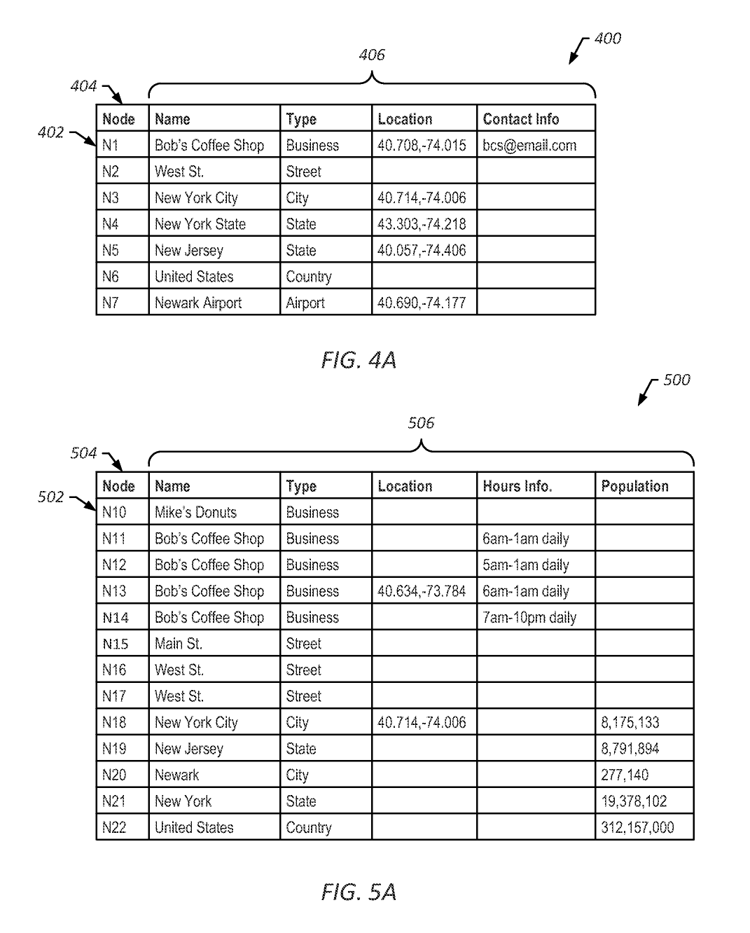

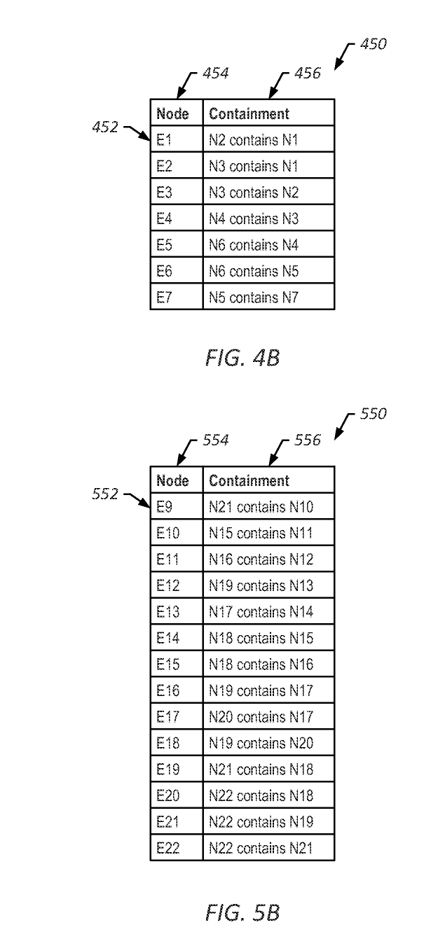

FIGS. 4A and 5A are diagrams that illustrate exemplary node listings 400 and 500 corresponding to nodes of first and second graphs 104 and 106, respectively, in accordance with one or more embodiments of the present technique. Node listings 400 and/or 500 may include a plurality of entries 402 or 502 that each correspond to respective nodes of the first and second graphs 104 and 106. For example, node listing 400 includes entries 402 corresponding to nodes N1-N7 of first graph 104 and node listing 500 includes entries 502 corresponding to nodes N10-N22 of second graph 106. In some embodiments, each entry 402 and/or 502 may include a node identifier 404 or 504 indicative of a node of graph 104 or 106 corresponding to the given entry. In some embodiments, each entry 402 and/or 502 of node listings 400 or 500 may include some or all node attributes 406 or 506 associated with the corresponding node. For example, in the illustrated embodiment, entries 402 of node listing 400 each include fields for node attributes 406 of “Name”, “Type”, “Location” and “Contact Information”. Entries 502 of node listing 500 each include fields for node attributes 506 of “Name”, “Type”, “Location”, “Hours” and “Population”. Name may define a name or other identifier of the entity/object associated with the given node. Type may define a type (e.g., a political type) associated with the given node. Location may include geographic coordinates, geographic boundaries, or other location information indicative of a geographic location of the entity/object associated with the given node. Contact information may include a telephone number, physical address, e-mail address, website, or the like for contacting the entity/object associated with the given node. Hours may include hours of operations (e.g., business hours) for the entity/object associated with the given node. Population may include an indication of the number of persons residing within an object, such as a neighborhood, city, county, state, country or the like. Other embodiments may include fields for any number and types of node attributes for conveying any information related to the entity/object associated with the given node.

FIGS. 4B and 5B are diagrams that illustrate exemplary edge listings 450 and 550 corresponding to edges of first and second graphs 104 and 106 in accordance with one or more embodiments of the present technique. Edge listings 450 and/or 550 may include a plurality of entries 452 or 552 that each correspond to respective edges of first or second graphs 104 and 106. For example, edge listing 450 includes entries 452 corresponding to edges E1-E7 of first graph 104 and edge listing 550 includes entries 552 corresponding to edges E9-E22 of second graph 106. In some embodiments, each entry 452 and/or 552 may include an edge identifier 454 or 554 indicative of an edge of graph 104 or 106 corresponding to the given entry. In some embodiments, each entry of edge listings 450 and/or 550 may include any edge attributes 456 or 556 associated therewith. For example, in the illustrated embodiments, each of edges E1-E7 and E9-E22 specifies a containment relationship between the two respective nodes of each given edge. Other embodiments may include any number and types of edge attributes for conveying any information related to the given edge (e.g., attributes defining a relationship between the two nodes of the given edge).

In some embodiments, datastore 108 may include databases of information, including data corresponding to graphs 104 and/or 106. For example, node listings 400 and/or 500, and/or edge listings 450 and/or 550 may be stored in datastore 108.

In some embodiments, graph 104 may include one or more nodes that correspond to one or more nodes of graph 106 (e.g. subject node set 110 may include one or more nodes that correspond to one or more nodes of candidate node set 112). For example, a given node of first graph 104 (e.g., a first node N1) and a given node of second graph 106 (e.g., a second node N12) may each correspond to the same object (e.g., Bob's Coffee Shop at a given location). In some embodiments, it may be desirable to establish a relationship between nodes that correspond to the same object. For example, where the first node is associated with a first set of node/edge attributes for the geographic object and the second node is associated with a second set of node/edge attributes for the geographic object, it may be desirable to identify a match between the two nodes such that a cumulative set of node/edge attributes (e.g., including the first and second sets of node/edge attributes) may be generated for the geographic object. For example, where it is determined that node N1 (e.g., corresponding to an entry 402 of node listing 400 having a given set of node attributes 406 including contact information) matches node N12, (e.g., corresponding to an entry 502 of node listing 500 having a given set of node attributes 506 including business hours), node attributes 506 including business hours may be combined with node attributes 406 including contact information to provide a single entry including a combined set of node attributes including business hours and contact information. That is, node and/or edge attributes may be derived from the combination of node and/or edge attributes of matching nodes.

In some embodiments, nodes of different graphs may be compared to one another or otherwise considered to identify related (e.g., matching) nodes and to generate a cumulative graph/node listing including a concise record of information for each of the given nodes. For example, a given node (e.g., a subject node N1) 114 of first graph 104 may be selected, and candidate node set 112 of second graph 106 may be filtered to determine whether or not candidate node set 112 includes a node that corresponds to subject node 114 (e.g., a matching node 116).

In some embodiments, candidate node set 112 may be initially filtered based on node attributes to identify one or more nodes corresponding to subject node 114. For example, candidate node set 112 may be filtered to identify any nodes of candidate node set 112 (e.g., a first subset of candidate nodes) having node attributes that are the same or similar to node attributes of subject node 114. Such filtering may filter out of nodes of candidate node set 112 that are unrelated to subject node 114. In some embodiments, where no related nodes remain as a result of filtering, it may be determined that candidate node set 112 does not include a node that matches subject node 114. In some embodiments, where a single related node of candidate node set 112 remains as a result of filtering, it may be determined that the remaining node matches subject node 114 (e.g., that the remaining node is a matching node 116 for subject node 114). In some embodiments, where one or more nodes of candidate node set 112 remain as a result of filtering, additional filtering may be applied to determine whether or not one or more of the remaining nodes matches subject node 114. For example, additional filtering may be provided based on edge attributes of the nodes. Filtering based on edge attributes may provide for matching subject node 114 to one or more nodes of candidate node set 112 that have a context that is similar to the context of subject node 114. In some embodiments, the additional filtering based on edge attributes may include iteratively considering levels of edge attributes (e.g., first level edge attributes, second level edge attributes and so forth) of subject node 114 and remaining nodes of the candidate node set 112 to identify whether or not a matching node exists for subject node 114. If a matching node is identified, attributes of subject node 114 and matching node 116 may be combined or otherwise associated with one another. For example, if node attributes of subject node 114 provide location information and contact information, and node attributes of matching node 116 provide hours information, the location information, contact information and hours information may be combined into a single entry of a listing of node such that a single entry for a node (e.g., subject node 114 and/or matching node 116) provides a concise and complete listing of nodes attributes for a given object corresponding to the node and the entry.

In some embodiments, each node of the subject node set of nodes may be iteratively considered to determine whether or not a matching node exists. For example, each of nodes of subject node set 110 of first graph 104 may be considered individually as subject node 114, to identify any matching node(s) of candidate node set 112 of second graph 106. As a result of identifying matching nodes, one or more nodes of second graph 106 may mapped to corresponding nodes (e.g., matching nodes) of first graph 104. As a result, two separate graphs and/or listings may be combined into a single graph and/or listing, where entries for nodes of the subject node set 110 having corresponding matching nodes of the candidate node set 112 are combined. In some embodiments, a single combined database may be created such that a query to the combined database for information relating to a given object may resulting in accessing a single entry for the given object in the combined database having node/edge attributes based on a subject node and/or a corresponding matching node, and responding to the query with information that is derived from the node/edge attributes of the first graph and/or node/edge attributes of the second graph that have been combined into the single entry of the combined database.

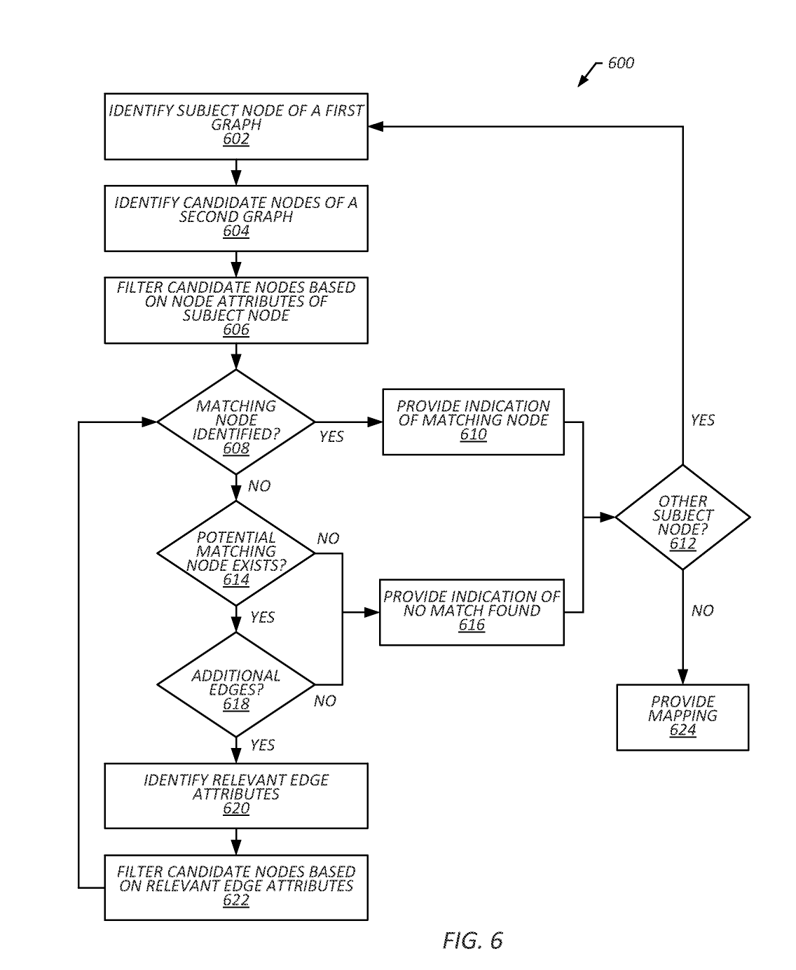

FIG. 6 is a flowchart that illustrates a method 600 of mapping nodes of two disconnected graphs in accordance with one or more embodiments of the present technique. Method 600 may generally include identifying a subject node of a first graph, identifying candidate nodes of a second graph, filtering the candidate nodes based on node attributes of the subject node, determining whether a matching node is identified. If a matching node is identified method 600 may include providing an indication of the matching node and processing other subject nodes. If a matching node is not identified, method 600 may include identifying any relevant edge attributes and filtering the remaining candidate nodes based on the relevant edge attributes to identify a matching node. If a matching node is identified method 600 may include providing an indication of the matching node and processing other subject nodes. If a matching node is not identified, method 600 may include identifying any relevant edge attributes (e.g., a next level of edge attributes) and filtering the candidate nodes based on the relevant edge attributes to identify a matching node. Such iterations may be repeated until a match is identified or no additional edge attributes remain. The processing described in method 600 may be repeated for some or all of the nodes of the first graph (e.g., nodes of subject node set 110) to generate a mapping of some or all of the nodes of the first graph to corresponding nodes of the second graph. Method 600 may also include providing the mapping of nodes of the first graph for processing and/or use in generating a corresponding combined graph/listing/database.

Method 600 may include identifying a subject node of a first graph, as depicted at block 602. Identifying a subject node of a first graph may include identifying a given one of nodes 202 (e.g., one of nodes N1-N6) of first graph 104 that has not yet been the subject of processing to map the given node to a corresponding/matching node of second graph 106. For example, where none of nodes N1-N6 have been processed, identifying a subject node of first graph 104 may include identifying any of nodes N1-N6 (e.g., node N3) as the subject node of first graph 104.

Method 600 may include identifying candidate nodes of a second graph, as depicted at block 604. In some embodiments, identifying candidate nodes of a second graph may include identifying all or substantially all of the nodes of second graph. For example, all of the nodes of candidate node set 112 (e.g., nodes N11-N22) may be identified as candidate nodes of second graph 106. In some embodiments, identifying candidate nodes of a second graph may include identifying the nodes of second graph 106 that have not yet been identified as matching subject node. For example, where node N22 had been identified as matching node N6 as a result of a previous round of processing, the other nodes of candidate node set 112 (e.g., nodes N11-N21) may be identified as candidate nodes of second graph 106.

Method 600 may include filtering candidate nodes based on node attributes, as depicted at block 606. Filtering candidate nodes based on node attributes may include filtering out candidate nodes that are not relevant to the subject node. In some embodiments, filtering may include identifying candidate nodes having a type that is similar to the subject node, having a name that is similar to the subject node, having a location that is similar to the subject node and/or the like. In some embodiments, filtering candidate nodes may include excluding candidate nodes that have node attributes that conflict with node attributes of the subject node. For example, where subject node 114 includes node N7 for “Newark Airport” having a type of “Airport”, filtering candidate node may include filtering out candidate nodes that are not of the type “Airport” such that no candidate nodes remain based at least on none of the nodes N10-N22 having a type of “Airport”.

As a further example, where subject node 114 includes a node N3 for “New York City” having a type of “City”, filtering candidate nodes may include filtering out candidate nodes that are not of the type “City” such that only nodes N18 for “New York City” and N20 for “Newark” having types of “City” remain.

In some embodiments, filtering may be based on a plurality of node attributes. For example, where subject node 114 includes a node N3 having a name “New York City”, a type of “City” and a location of “40.714,-74.006”, filtering candidate node may include filtering out candidate nodes, that do not have a similar name to the subject node (e.g., the names of the subjects and candidate node having a relative string edit distance greater than five), that are not of the same type as the subject node, and/or the that have locations that are not located within a given distance (e.g., five miles) of the geographic location of the subject node such that only node N18 corresponding to “New York City” remains.

As a further example, where subject node 114 includes a node N1 having a name “Bob's Coffee Shop”, a type of “Business” and a location of “40.708,-74.015”, filtering candidate node may include filtering out candidate nodes, that do not have a similar name to the subject node (e.g., the names of the subjects and candidate node having a relative string edit distance greater than five), that are not of the same type as the subject node, and/or the that have locations that are not located within a given radius/distance (e.g., five miles) of the geographic location of the subject node such that nodes N10, N13 and N15-N22 are filtered-out, and only nodes N11, N12 and N14 having names corresponding to “Bob's Coffee Shop” and type of “Business” remain. Notably, N13 may be excluded based on the distance between location “40.708,-74.015” and location “40.634,-73.784” exceeding the given radius/distance of five miles. In some embodiments, nodes that do not specify a location may not be filtered out as the determination of whether or not they fall outside of the given radius/distance may not be determined due to the lack of information.

Method 600 may include determining whether a matching node has been identified, as depicted at block 608. Determining whether a matching node has been identified may include determining whether a single matching node has been identified, whether no nodes have been identified, or whether multiple nodes have been identified. In some embodiments, where a single related node of candidate node set 112 remains as a result of filtering, it may be determined that the remaining node matches the given subject node 114 (e.g., that the remaining node is a matching node 116 for subject node 114). For example, where subject node 114 includes node N3, and only node N18 corresponding to “New York City” remains after filtering at block 606, N18 may be identified as a matching node 116 for subject node N3.

Upon determining that a matching node has been identified, at block 608, method 600 may include providing an indication of the matching node and/or proceeding to processing of other subject nodes, as depicted at blocks 610 and 612 respectively.

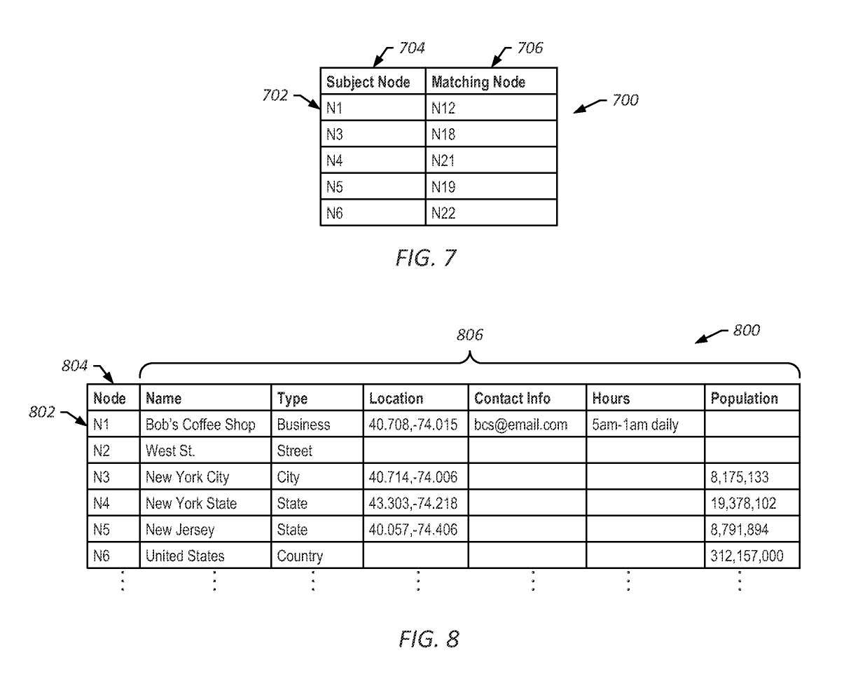

In some embodiments, providing an indication of the matching node 601 may include providing a corresponding mapping of the given matching candidate node to the given subject node. FIG. 7 is a diagram that illustrates an exemplary mapping 700 of nodes of first graph 104 to corresponding nodes of second graph 106 in accordance with one or more embodiments of the present technique. Each entry 702 of table 700 provides a mapping of a given subject node 704 to a given matching node 706. For example, the first entry include a mapping of node N3 of first graph 104 to node N18 of second graph 106 in accordance with the previously discussed match identified at block 608. The other mappings may be the results of additional iterations of processing subject nodes as discussed herein.

In some embodiments, where no candidate nodes remain as a result of filtering, it may be determined that candidate node set 112 does not include a node that matches subject node 114 at block 608, and/or that no matching node exists at block 614. For example, where subject node 114 includes node N7 for “Newark Airport” no candidate nodes remain after filtering at block 606, it may be determined that no matching node is identified, and that that candidate node set 112 does not include a node that matches subject node N7.

Upon determining that a matching node does not exist at block 614, method 600 may include providing an indication of no match found and/or proceeding to processing of other subject nodes, as depicted at blocks 616 and 612 respectively. In some embodiments, providing an indication of no match found may include not providing a corresponding mapping entry to table 700 and/or providing an entry that indicates a lack of a mapping from the subject node N7 to another node of candidate node set 112. For example, a listing with the subject node N7 and the corresponding matching node field left blank.

In some embodiments, where one or more nodes of candidate node set 112 remain as a result of filtering, it may be determined that a matching node has not yet been identified at block 608 and/or that a matching node may exists, at block 614, and method 600 may include applying additional processing/filtering to determine whether or not one of the remaining nodes matches subject node 114. For example, where subject node 114 includes node N1 having a name “Bob's Coffee Shop”, a type of “Business” and a location of “40.708,-74.015”, only nodes candidate node N11, N12 and N14 may remain, and additional processing/filtering may be provided to determine whether or not one of the remaining nodes N11, N12 and N14 matches subject node N1.

In some embodiments, method 600 may include determining whether or not additional levels of edges are available for processing, as depicted at block 618. Determining whether additional edges are available may include determining whether a first level of edges exists for the subject node and/or the remaining candidate nodes. Upon each iteration through steps 608-622, the edge level may iteratively increase (e.g., first, second, third, fourth, and so forth).

Where it is determined that no additional edges are available, it may be determined that no particular match for the given subject node can be found, and method 600 may include providing an indication of no match found and/or proceeding to processing of other subject nodes, as depicted at blocks 616 and 612 respectively. For example, where three candidate nodes remain as potential matches to the subject node, and there are no additional edge levels to consider, which of the three candidate nodes is a matching node, if any, may not be determined as there are no additional contextual criteria/information/attributes for comparing the candidate nodes to the subject node. In some embodiments, providing an indication of no match found may include at least providing an indication of the remaining candidate nodes (e.g., the three remaining candidate nodes). For example, a listing of table 700 may include the subject node N7 and the corresponding matching node filed including N11, N12 and N14.

Where it is determined that addition levels of edges are available for processing, method 600 may proceed to identifying relevant ones of the edge attributes and/or filtering candidate nodes based the relevant edge attributes identified, as depicted at blocks 620 and 622. For example, where subject node 114 includes node N1 and candidate node N11, N12 and N14 remain as a result of filtering at block 606, it may be determined that additional levels of edges are available for processing. For example, first level edges E1 and E2 of node N1, first level edge E10 of node N11, first level edge E11 of N12, and first level edge E13 of node N14 are available for consideration.

In some embodiments, identifying relevant edge attributes may include identifying edge attributes corresponding to the current level of edges being considered. For example, upon the first iteration through steps 608-622, identifying edge attributes corresponding to the current level of edges being considered may include identifying edge attributes of the first level edges (e.g., edges E1, E2, E10, E11 and E13) for the subject node (e.g., node N1) and remaining candidate nodes (e.g., N11, N12 and N14). Subsequent iterations through steps 608-622, may include identifying edge attributes corresponding to the current level of edges being considered (e.g., second level, third level, fourth level, and so forth). Relevant edge attributes may include, for example, containments specified for each of the edges in tables 450 and 550 as discussed above with regard to FIGS. 4B and 5B.

Method 600 may include filtering candidate nodes based on relevant edge attributes, as depicted at block 622. In some embodiments, filtering candidate nodes based on relevant edge attributes may include excluding (e.g., filtering out) candidate nodes that have node attributes that conflict with node attributes of the subject node. For example, where edge attributes for E1 specify that subject node N1 is contained by node N2 (e.g., that Bob's Coffee Shop of node N1 is on West St.) and where edge attributes for E2 specify that node N1 is contained by node N3 (e.g., that Bob's Coffee Shop of node N1 is in New York City), node N11 may be filtered out as a possible matching node due to edge attributes of E10 specifying that node N11 is contained by node N15 (e.g., that Bob's Coffee Shop of node N11 is located on Main St.—not West St.), node N12 may remain as a possible matching node due to edge attributes of E11 specifying that node N12 is contained by node N16 (e.g., that Bob's Coffee Shop of node N12 is also located on West St.), and node N14 may remain as a possible matching node due to edge attributes of E13 specifying that node N14 is contained by node N17 (e.g., that Bob's Coffee Shop of node N14 is also located on West St.). Accordingly, nodes N12 and N14 may remain as potential matching nodes of graph 106 for subject node N1 of graph 104 and node N11 may be filtered out.

As discussed above with regard to block 608 and 614, due to two potential matching nodes remaining, it may be determined that a matching node has not yet been identified at block 608, and that a matching node may still exists at block 614.

Method 600 may include determining whether or not additional levels of edges are available for processing, as depicted at block 618. Where first level edges and corresponding edge attributes have been considered, determining whether additional edges are available may include determining whether a next level of edges (e.g., a second level of edges) exists for the subject node and/or the remaining in candidate nodes. For example, where subject node 114 includes node N1 and candidate nodes N12 and N14 remain as a result of filtering at block 606 and a first iteration of filtering at block 622, it may be determined that additional levels of edges are available for processing. For example, second level edges E3 and E4 of node N1, second level edge E15 of N12, and second level edges E16 and E11 of node N14 are available for consideration.

Method 600 may include a second iteration of filtering candidate nodes based on relevant edge attributes, as depicted at block 622. In some embodiments, a second iteration of filtering candidate nodes based on relevant edge attributes may include excluding (e.g., filtering out) candidate nodes that have first and/or second level node attributes that conflict with first and/or second node attributes of the subject node. For example, where edge attributes for E3 specify that subject node N2 is contained by node N3 (e.g., that Bob's Coffee Shop of node N1 is on West St. which is in New York City) and edge attributes for E4 specify that node N3 is contained by node N4 (e.g., that Bob's Coffee Shop of node N1 is in New York City which is in New York State), node N14 may be filtered out as a possible matching node due to edge attributes for E16 specifying that node N17 is contained by node N19 (e.g., that Bob's Coffee Shop of node N14 is located on West St. in New Jersey—not New York State) and/or due to edge attributes for E11 specifying that node N17 is contained by node N20 (e.g., that Bob's Coffee Shop of node N14 is located on West St. in Newark—not New York City), and node N12 may remain as a possible matching node due to edge attributes for E15 specifying that node N16 is contained by node N18 (e.g., that Bob's Coffee Shop of node N12 is also located on West St. in New York City). Accordingly, node N14 may be filtered out, and node N12 may remain as the only potential matching node of graph 106 for subject node N1 of graph 104. It may be determined that a matching node (e.g., N12) has been identified, at block 608, and method 600 may include providing an indication of the matching node, as depicted at block 610. For example, table 700 may be populated with a second entry include a mapping of node N1 of first graph 104 to node N12 of second graph 104.

Method 600 may include identifying whether other subject nodes require processing, as depicted at block 612. In some embodiments, identifying whether other subject nodes require processing includes determining whether at least one other node of subject node set 110 has not yet been identified as a subject node and/or subjected to processing as described with regard to method 600. Where it is determined that at least one other node of subject node set 110 has not yet been identified as a subject node and/or subjected to processing as described with regard to method 600, method 600 may include returning to another iteration of at least steps 602-622 for at least the one other node. For example, where nodes N7, N1 and N3 of first graph 104 have already been identified as a subject node and have been subject to processing as described with regard to method 600, it may be determined that at least nodes N2 and N4-N6 may still require processing, and method 600 may include identifying one of nodes N2 and N4-N6 as a subject node at step 602 and providing for corresponding processing of the subject node in an attempt to identify a matching node of the second graph. In some embodiments, each node of first graph 104 may be processed such that any matching nodes of second graph 106 are identified for each of the nodes of first graph 104.

Where it is determined that all of the nodes of subject node set 110 have been identified as a subject node and/or subjected to processing as described with regard to method 600, method 600 may include providing a mapping, as depicted at block 624. In some embodiments, providing a mapping may include providing a mapping of some or all of the nodes of subject node set 110 of first graph 104 to corresponding matching nodes of candidate node set 112 of second graph 106. As noted above, FIG. 7 is a diagram that illustrates a mapping 700 of nodes of first graph 104 to corresponding nodes of second graph 106, in accordance with one or more embodiments of the present technique. Mapping 700 may be generated as a result of iterating through method 600 for each of subject nodes N1-N7 of first graph 104. In some embodiments, the mapping may be provided for storage or additional processing. For example, in some embodiments, mapping 700 may be used to generate a combined node graph/listing/database that include node attributes for given nodes of first graph 104 combined with node attributes of corresponding matching nodes of graph 106. FIG. 8 is a diagram that illustrates an exemplary combined node attribute listing 800 in accordance with one or more embodiments of the present technique. In some embodiments, entries 802 for given nodes 804 may include a combination of node attributes 806 associated with a given node 404 of listing 400 and node attributes associated with a corresponding (e.g., matching) node/entry 502 of listing 500. For example, the first entry 402 corresponding to node N1 includes combined node attributes 806 including “Location” and “Contact Information” (based on node attributes 406 of an entry 402 of node listing 400 corresponding to node N1), and “Hours” information (based on node attributes 506 of an entry 502 of node listing 500 corresponding to node N12, determined to match node N1 according to mapping 700 as described above). Similar combinations of node attributes may be provided for other node entries, as depicted. In some embodiments, combined node attribute listing 800 may be stored to provide a combined database of information based on the combination of a database for first graph 104 (e.g., node listing 400) and a database for second graph 106 (e.g., node listing 500) in accordance with mapping 700.

Method 600 is an exemplary embodiment of a method employed in accordance with techniques described herein. Method 600 may be may be modified to facilitate variations of its implementations and uses. Method 600 may be implemented in software, hardware, or a combination thereof. Some or all of method 600 may be implemented by mapping module 102. The order of method 600 may be changed, and various elements may be added, reordered, combined, omitted, modified, etc.

Exemplary Computer System

FIG. 9 is a diagram that illustrates an exemplary computer system 1000 in accordance with one or more embodiments of the present technique. Various portions of systems and methods described herein, may include or be executed on one or more computer systems similar to system 1000. For example, mapping system 100 may include a configuration similar to at least a portion of computer system 1000. Further, methods/processes/modules described herein may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1040. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method of associating a node of a first graph with a node of a second graph, each of the first and second graphs comprising sets of nodes each corresponding to a physical entity having a physical geographic location and one or more node attributes associated therewith, comprising:
identifying a subject node of the first graph;
filtering out nodes of the second graph that are unrelated to the subject node of the first graph to identify a first subset of candidate nodes;
identifying one or more first level edge attributes associated with the subject node, the first level edge attributes characterizing a relationship between the subject node and first level nodes of the first graph adjacent to the subject node; and
filtering out nodes of the first subset of candidate nodes having first level edge attributes that do not correspond to the one or more first level edge attributes associated with the subject node to identify a second subset of candidate nodes.

2. The method of claim 1, further comprising iteratively identifying increasing levels of edge attributes associated with the subject node and increasing levels of edge attributes associated with the nodes of the second graph and filtering out nodes of the second graph having edge attributes that do not correspond to one or more edge attributes associated with the subject node.

3. The method of claim 2, wherein the iterations of identifying increasing levels of edge attributes associated with the subject node and increasing levels of edge attributes associated with the nodes of the second graph and filtering out nodes of the second graph having edge attributes that do not correspond to one or more edge attributes associated with the subject node are repeated until a single node of the second graph corresponding to the subject node is identified.

4. The method of claim 1, wherein filtering out nodes of the second graph that are unrelated to the subject node of the first graph to identify a first subset of candidate nodes comprises filtering out nodes of the second graph having one or more node attributes that conflict with one or more node attributes of the subject node.

5. The method of claim 1, wherein filtering out nodes of the second graph that are unrelated to the subject node of the first graph to identify a first subset of candidate nodes comprises filtering nodes of the second graph having a node attribute of at least one of an identifier, a type, or a geographic characteristic that conflicts with at least one of an identifier, a type, or a geographic characteristic of a node attribute of the subject node.

6. The method of claim 1, wherein filtering out nodes of the first subset of candidate nodes having first level edge attributes that do not correspond to the one or more first level edge attributes associated with the subject node to identify a second subset of candidate nodes comprises filtering out nodes of the first subset of candidate nodes having first level edge attributes that conflict with the one or more first level edge attributes associated with the subject node to identify a second subset of candidate nodes.

7. The method of claim 1, further comprising
identifying one or more second level edge attributes associated with the subject node, the second level edge attributes characterizing a relationship between the first level nodes adjacent the subject node and second level nodes adjacent to the first level nodes; and
filtering out nodes of the second subset of candidate nodes having first or second level edge attributes that do not correspond to the one or more first or second level edge attributes associated with the subject node to identify a third subset of candidate nodes.

8. The method of claim 1, further comprising identifying one or more nodes of the second subset of candidate nodes as matching the subject node.

9. The method of claim 8, further comprising combining node attributes of the subject node with node attributes of the one or more nodes of the second subset of candidate nodes identified as matching the subject node.

10. The method of claim 9, further comprising storing the combined node attributes in a combined database.

11. The method of claim 1, wherein the first graph corresponds to a first database comprising a set of subject nodes, and wherein the second graph corresponds to a second database comprising a set of candidate nodes.

12. The method of claim 1, wherein the physical entity having a physical geographic location comprises at least one of an place, landmark, business, street, neighborhood, city, county, state, or county.

13. The method of claim 1, wherein at least one or more first level edge attributes associated with the subject node specifies a directed edge attribute.

14. The method of claim 1, wherein at least one or more first level edge attributes associated with the subject node specifies a containment.

15. The method of claim 1, wherein the first graph is disconnected from the second graph.

16. The method of claim 1, wherein the first subset of candidate nodes comprises one or more candidate nodes.

17. The method of claim 1, wherein the second subset of candidate nodes comprises one or more candidate nodes.

18. A non-transitory computer readable storage medium having computer-executable program instructions stored thereon, that are executable by a computer to cause steps comprising:
identifying a subject node of a first graph comprising a set of nodes each corresponding to a physical entity having a physical geographic location and one or more node attributes associated therewith;
filtering out nodes of a second graph that are unrelated to the subject node of the first graph to identify a first subset of candidate nodes, the second graph comprising a set of nodes each corresponding to a physical entity having a physical geographic location and one or more node attributes associated therewith;
identifying one or more first level edge attributes associated with the subject node, the first level edge attributes characterizing a relationship between the subject node and first level nodes of the first graph adjacent to the subject node; and
filtering out nodes of the first subset of candidate nodes having first level edge attributes that do not correspond to the one or more first level edge attributes associated with the subject node to identify a second subset of candidate nodes.

19. A system, comprising:
a processor;
a memory; and
a mapping module stored on the memory, the mapping module configured to be executed by the processor to cause:
identifying a subject node of a first graph comprising a set of nodes each corresponding to a physical entity having a physical geographic location and one or more node attributes associated therewith;
filtering out nodes of a second graph that are unrelated to the subject node of the first graph to identify a first subset of candidate nodes, the second graph comprising a set of nodes each corresponding to a physical entity having a physical geographic location and one or more node attributes associated therewith;
identifying one or more first level edge attributes associated with the subject node, the first level edge attributes characterizing a relationship between the subject node and first level nodes of the first graph adjacent to the subject node; and
filtering out nodes of the first subset of candidate nodes having first level edge attributes that do not correspond to the one or more first level edge attributes associated with the subject node to identify a second subset of candidate nodes.

20. A method for associating nodes of a first graph with nodes of a second graph disconnected from the first graph, comprising:
identifying candidate nodes of the second graph that correspond to a subject node of the first graph by comparing node attributes of the nodes of the second graph to one or more node attributes of the subject node; and
iteratively filtering, using a computer, the candidate nodes identified as corresponding to the subject node of the first graph by iteratively comparing increasing levels of edge attributes of the candidate nodes of the second graph remaining to corresponding levels of edge attributes of the subject node.
